(19) United States
(12) Patent Application Publication
(10) Pub. No.: US 2026/0223873 A1
(43) Pub. Date: Aug. 6, 2026

(54) EDIBLE COATINGS FOR FRESH FRUIT

(71) Applicant: DEAD SEA BROMINE COMPANY LTD., Beer-Sheva (IL)

(72) Inventors: Mohammed ABUELHAIGA, Kibbutz Mefalsim (IL); Alexander FRENKLACH, Lehavim (IL); Andrey BERMAN, Beer Sheva (IL); Nikolay FUX, Beer Sheva (IL); Reut ISRAELI, Meitar (IL)

(73) Assignee: DEAD SEA BROMINE COMPANY LTD., Beer-Sheva (IL)

(21) Appl. No.: 19/149,932

(22) PCT Filed: Jan. 22, 2024
(86) PCT No.: PCT/IL2024/050088

§ 371 Date: Jul. 22, 2025

Related U.S. Application Data
(60) Provisional application No. 63/440,446, filed on Jan. 23, 2023.

(51) Int. Cl. A23B 7/16

(52) U.S. Cl. CPC A23B 7/16

(57) ABSTRACT

The invention relates to a method of prolonging the shelf life of postharvest produce, comprising creating on the exterior surface of the produce an edible coating that contains one or more polysaccharides modified by a basic alkaline earth metal compound, e. g., magnesium oxide. A nearly neutral-moderately alkaline filmogenic formulation comprising a polysaccharide and a basic alkaline earth metal compound in water is also provided.

Magnesium oxide (magnesia; MgO) has a wide range of applications: a filler additive in polymers; a food supplement, a pharmaceutically active ingredient (antacid or laxative), a pharmaceutical excipient; and in the steel industry, for producing forsterite (Mg₂SiO₄) coatings.

A recently reported use of MgO in a co-assigned international publication (WO 2022/234582) relates to the agricultural sector. It was shown that an aqueous suspension of MgO, when applied to harvested fruits and vegetables, e.g., citrus fruits, suppresses decay processes and prolongs the shelf life of the fruits.

We have now found that postharvest produce can benefit from MgO in another way, namely, by incorporating MgO into an edible, polysaccharide-based, protective film coating applied on the exterior surface of fruits and vegetables (whole or cut/sliced).

Edible films are used to coat a product to extend its shelf life and can be consumed with the product. One example of a film-forming polysaccharide is pectin, which is widely used as the jelling agent in fruit jellies. Addition of MgO to pectin to produce desserts was described in U.S. Pat. No. 3,367,784. Such dessert gels are often kept at acidic pH, around the natural pH of low-methoxy pectin (<25% methoxylation) which is ~3.5, with the aid of a citrate buffer that is added to the gel composition. However, it appears that hitherto, modification of polysaccharide films (e.g., pectin/algin films) for the purpose of coating fruits and vegetables was largely based on addition of calcium salts such as calcium chloride, calcium lactate, calcium ascorbate and dicalcium phosphate to the polysaccharide (U.S. Pat. Nos. 2,517,595, 2,703,286, JP 48031907, EP 591079, WO 97/23138, EP 3087843 and ES 2918330) or alkali hydroxide, carbonate or bicarbonate (WO 2016/084094).

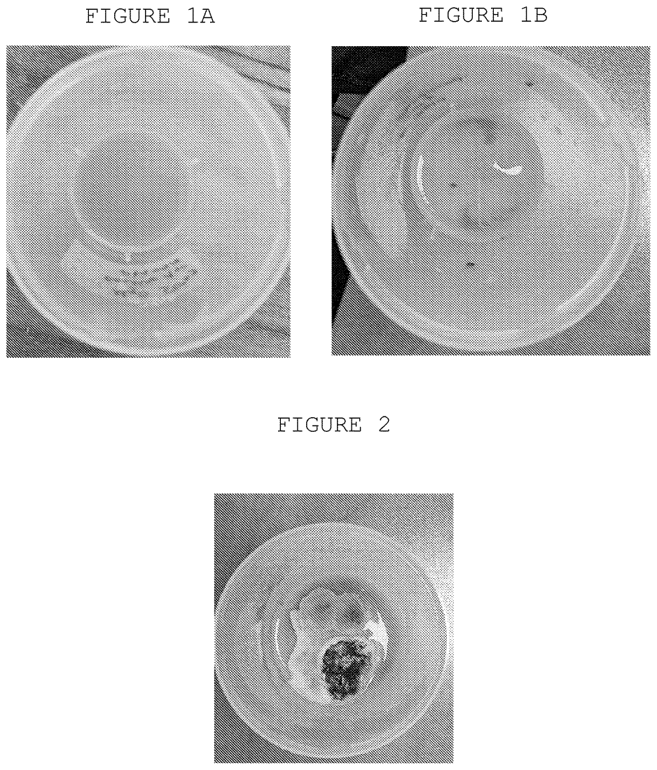

When left non-refrigerated, pectin gels are not only unstable against phase separation, but they are also susceptible to fungal colonization/proliferation. We have found that the development of fungal colonies in gelled polysaccharides such as pectin gel can be suppressed over a long, non-refrigerated, storage period by addition of basic alkaline earth metal compound, e.g., magnesium compound (magnesium oxide, magnesium hydroxide, magnesium hydroxide carbonate or magnesium carbonate). MgO-modified pectin gel shows good storage stability and resistance to fungal colonization for long weeks to months. The effect is shown in FIG. 1, which refers to the experimental results reported below. MgO-modified gel (MgO:pectin:water—0.1:1:50, pH=9.7) and nonmodified pectin gel (pectin:water—1:50, pH=3.7) are seen in the left (1A) and right (1B) photographs of FIG. 1, respectively. Phase separation and spoilage were observed in the nonmodified pectin gel, whereas the MgO-modified gel remained intact (after two weeks at non-refrigerated storage).

The nearly neutral-moderately alkaline MgO-modified polysaccharides of the invention are filmogenic, and can be used to prepare coatings, as they can form an invisible protective layer on many different surfaces, e.g., fruits, such as fresh citrus fruit. The protective coating can potentially form a physical barrier to slow down the ripening process by limiting water loss (transpiration) or oxidation.

Accordingly, one aspect of the invention is a method of prolonging the shelf life of postharvest produce (fruit and vegetable), comprising creating on the exterior surface of the produce an edible coating that contains one or more polysaccharides modified by a basic alkaline earth metal compound (magnesium compound, e.g., magnesium oxide, magnesium hydroxide, magnesium hydroxide carbonate and magnesium carbonate; preferably magnesium oxide).

The invention also relates to the use of a basic alkaline earth metal compound (magnesium oxide, magnesium hydroxide, magnesium hydroxide carbonate and magnesium carbonate) as a stabilizer of edible, polysaccharide-based, filmogenic formulation, and coating made therefrom, against phase separation and fungal spoilage, wherein the pH of the filmogenic gel and coating is nearly neutral-moderately alkaline (e.g., 6<pH≤12, e.g., 7<pH≤12).

Magnesium oxide can be incorporated into the coating by dispersing MgO powder in a solution of the gellable polysaccharide, to form a filmogenic formulation for use in coating a produce. For example, a coating formulation is prepared by dissolving gellable polysaccharide such as pectin in water, usually at a weight ratio of not less than 1:75, e.g., not less than 1:50, e. g., from 1:50 to 5:50 (1:50 to 3:50). After dissolution, a basic magnesium compound, in a powder form, or in the form of an aqueous dispersion, is added to the polysaccharide, in a weight ratio of, e.g., 1:25 to 1:5, e.g., 1:20 to 1:8, e.g., 1:15 to 1:10 (MgO:pectin). The magnesium oxide is dispersed by vigorous stirring into the viscous polysaccharide solution/progressively jellifying composition. A filmogenic formulation is formed, with a nearly neutral-moderately alkaline pH (e.g., 6<pH≤12, e.g., 7≤pH≤12, e.g., ~7.5≤pH≤10.5, for example, a pH value of between 9.0 and 10). The filmogenic formulation jellifies over different, MgO concentration-dependent, time periods. Thus, the filmogenic formulation provided by the invention may be in the form of a viscous liquid, a gellable suspension or a gel displaying fluidity (e.g., a gel which upon stirring/blending becomes spreadable, brushable, sprayable, etc., such that it can be applied onto the produce). For example, in terms of the Bloom number (a test measuring the strength of a gel), alkaline, MgO-containing filmogenic pectin gels of the invention preferably show a low Bloom number (e.g., from 50 to 125 for 4% pectin solution; but gels having higher Bloom number, e.g., up to 500, are also workable).

Accordingly, another aspect of the invention is a nearly neutral-moderately alkaline filmogenic formulation comprising a polysaccharide and a basic alkaline earth metal compound (e.g., Mg mineral, such as magnesium oxide, magnesium hydroxide, magnesium hydroxide carbonate and magnesium carbonate) in water.

Polysaccharides useful in the invention have the capacity to form gels in the presence of Mg²⁺ and need to show stability over an alkaline pH range created by the added magnesium mineral, e.g., magnesia. Acidic polysaccharides are useful in the invention. Most acidic polysaccharides contain carboxylic groups; non-limiting examples of such acidic polysaccharides include pectin and algin. Another type of acidic polysaccharides contemplated by the invention consists of linear sulfated polysaccharides, in which the acidic group is —OSO₃⁻, such as carrageenan (iota-carrageenan). It should be noted that the acidic polysaccharides may be used in the form of the free acid and partially esterified derivatives; when dissolved in water, the partially esterified derivatives show acidic pH. Addition of MgO in such a case affords nearly neutral or moderately alkaline, edible filmogenic formulation based on magnesium pectate. But alkali metal or ammonium salts of acidic polysaccharides can also be used as starting materials, e.g., salts obtained by partial or complete neutralization of the acidic polysaccharide with NaOH. In that case, addition of Mg mineral affords an alkaline, edible filmogenic formulation based on magnesium-sodium pectate.

For example, MgO was formulated with commercial low methoxy pectin powder in water to form filmogenic formulation (pectin is classified according to the degree of methoxylation; in low methoxy pectin, the percentage of carboxylic groups that are esterified with methyl groups is less than 50%). Preferred are low methoxy pectin with a degree of methoxylation below 40%, 30%, 25%. The pH of native gels made of low methoxy pectin is roughly from 3 to 5; the pH of the MgO-modified pectin gel is shifted to the nearly neutral, slightly alkaline range (e.g., 6<pH≤12), in particular, moderately alkaline range (7.5≤pH≤10.5, such as 7.5≤pH≤9, or 9≤pH≤10.0, or 9.5≤pH≤10.0). It is suggested that in the presence of water insoluble basic Mg²⁺ compounds, namely, magnesium minerals, gelation is promoted by the interaction between pairs of free carboxylic groups of different chains that associate with, or bind to, the Mg²⁺ cation, and the uptake of excess MgO by the gel accounts for the alkaline pH of the resultant composition. The strength of the filmogenic gel, and films obtained therefrom upon drying on the surface of the fruit, increases with an increasing amount of the basic magnesium mineral in the composition. As noted previously, an effective weight ratio MgO:pectin is preferably in the range of 1:25 to 1:5. Excessive loading of MgO may result in separation of the mineral from the gel, and sediment formation.

One method of preparing the filmogenic formulations by dissolving the polysaccharide in water (e.g., at weight ratio in the range from 1:100 to 5:100), and gradually adding a well-dispersed aqueous suspension of the mineral, e.g., in a dropwise or portionwise manner. Stable aqueous suspensions of MgO or Mg(OH)₂ in water, that can be used in the invention, contain up to 50% solids (by weight; e.g., from 5 to 25%) and their preparation is achieved with the aid of high-shear dispersers, for example, revolutions per minute (rpm) of the mixing shaft is not less than 3000, operating in a range of rotor tip speeds between 3000 and 5000 ft/min. It is also possible to add a blend consisting of pectin powder and the mineral powder to water under vigorous stirring to obtain a homogeneous gel. The methods described herein are applicable to other acidic, gellable polysaccharides. The gels obtained are fluid while kept at room temperature and solidify after cooling (settling).

Pectin for use in the invention is commercially available in a powder form, e.g., a lyophilized powder. Pectin powders are obtained from fruits with high pectin content, e.g., citrus fruits (chiefly orange, lemon and grapefruit) and apples. For example, dried apple pulp generally contains 15 to 20% pectin and dried citrus peels range between 30 to 358 of pectin (see Lara-Espinoza et al, Molecules 2018 April; 23(4):942). Methods of preparing pectin by extraction from orange peels is found in a recently published review [Shinde et al., Journal of Emerging Technologies and Innovative Research April 2022, Volume 9, Issue 4].

We have found that the aqueous phase separated from a slurry of comminuted fruit (pectin-rich parts of the fruit, e.g., peels, in the case of citrus fruits) and water is a useful source of pectin for preparing MgO-modified edible films. The slurry can be produced by cutting/crushing the peels (e.g., orange peels, albedo and flavedo) in water or an aqueous mixture (with co-solvent), to reduce the peels to finely divided particles. Size reduction takes place in a blender or any other machine that cuts the peels. The water fluidizes the peels during the size reduction process and solubilizes the pectin and other water-soluble components of the peels. Usually, the weight ratio between the peels and water is from 1:1 to 1:3. Once a uniform suspension is formed, the soluble pectin-containing aqueous phase is recovered, e.g., by filtration (through a cloth or a screen with an appropriate mesh size). Next, the mineral, in a solid or suspension form, is added to the pectin to promote gelation with vigorous stirring. Experimental results reported below show that the so-formed formulation is filmogenic, turning into a coating with acceptable appearance, texture and smell upon application and drying on fruits. Storage stability tests showed that the edible films thus formed retain good stability during storage at room temperature and refrigeration.

Thus, specific aspects of the invention relate to a nearly neutral-moderately alkaline filmogenic formulation, and method of using it to form a coating onto produce, wherein the pectin is supplied in a solubilized form in a liquid phase that was separated from a slurry of comminuted fruit, e.g., pectin-containing aqueous phase recovered from a slurry of comminuted citrus peels and water.

Turning now to the basic alkaline earth metal compound that can be used in the invention, MgO and Mg(OH)₂ are both good options. Magnesium oxide consists of a powder with >98% assay; particle size distribution (PSD) characterized by d₁₀, d₅₀ and d₉₀ values such that d₁₀≤1.5 μm (e. g., from 0.5≤d₁₀≤1.3); 1.5 μm≤d₅₀≤6.0 μm (e.g., from 1.5≤d₅₀≤5.0 μm) and 5.0 μm≤d₉₀≤45.0 μm (measured by laser diffraction); specific surface area above 5.0 m²/gr, preferably from 5.0 to 25.0 m²/gr, more preferably from 5.0 to 15.0 m²/gr, more preferably from 5.0 to 10 m²/g (measured by the BET method); citric acid activity (CAA₄₀) ranging from 25 to 300 seconds, preferably from 80 to 200 seconds, e.g. from 150 to 200 seconds (CAA₄₀ is an index of the reactivity of MgO, as it is the time required for a 0.4 N aqueous citric acid solution containing phenolphthalein as an indicator to be neutralized when it is mixed with a final reaction equivalent of the tested magnesium oxide); loss on ignition (LOI, a measure of residual content of magnesium hydroxide) in the range of 0.1 to 8.0% by weight, e.g., from 4.0 to 8.0%, preferably from 0.2 to 3.0% or from 0.2 to 1.0% by weight; and bulk density in the range of 0.25 to 0.60 gr/ml. For example, MgO grade which is characterized by having a particle size distribution with d₁₀ ranging from 0.8 to 1.5 μm, by a d₅₀ ranging from 2.5 to 6.0 μm and by a d₉₀ ranging from 10.0 to 45 μm, a surface area ranging from 5.0 to 15.0 m²/gr, LOI ranging from 2.0 to 8.0%, bulk density ranging from 0.25 to 0.35 gr/ml and by citric acid activity (40) ranging from 100 to 200 seconds, can be used.

Grades of magnesium hydroxide suitable for use in the invention may be selected from commercially available products showing particle size distribution of 1.1≤d₅₀≤1.4 μm, 1.45≤d₅₀≤1.75 μm, or 1.8≤d₅₀≤2.3 μm, particles with tapped density of 0.5 gr/cc to 1.0 gr/cc.

The filmogenic formulation is applied to an exterior surface of a produce (onto the rind, peel, or skin in the case of a whole fruit, but in the case of peeled, skinned, or sliced fruit, the exterior surface is provided by any exposed part of the fruit, e.g., the orange flesh), by conventional techniques such as dipping, brushing, or spraying. The alkaline coating is allowed to dry, e.g., first at an elevated temperature for a short period of time to accelerate the process, then at room temperature. Examples of produce that can be coated by the filmogenic formulation of the invention include citrus fruits (e.g., orange, grapefruit, pomelo, and tangerine), stone fruits (peach, plum, and cherry), apple, pear, and berries; and vegetables. The filmogenic formulation is put to use (i.e., for coating formation onto produce) shortly after preparation, e.g., as a viscous, yet easily spreadable liquid, or after storage (the gel that is formed during storage restores fluidity upon stirring or blending). Usually, the filmogenic formulation of the invention is free of auxiliary ingredients such as wax. The filmogenic formulation of the invention is also usually free of alkaline agents based on alkali metals. The filmogenic formulation may contain customary additives, e.g., a plasticizer such as glycerin (usually at a concentration of up to 1% by weight) to prevent coating failures and defects (e.g., flaking). Other additives include mono- and di-saccharides, such as sucrose, up to 1% by weight.

Thus, the invention provides a method of prolonging the shelf life of postharvest produce, comprising applying a filmogenic formulation of a polysaccharide, to which MgO was added, onto the exterior surface of a fruit or vegetable, wherein the filmogenic formulation is nearly neutral-moderately alkaline (6<pH≤12, e.g., 7<pH≤12, e.g., 7.5<pH<10.5, e.g., 7.5<pH<9, or 9<pH<10.0, or 9.5<pH<10.0) and drying to form an edible film coating.

The invention also relates specifically to an alkaline filmogenic formulation in the form of a gellable MgO-suspension, or a stirrable MgO-containing gel, that is flowable on stirring or blending.

The methods described above for preparing edible coatings based on an MgO-modified filmogenic formulation involve the step of co-formulating pectin and the mineral in water beforehand, and subsequently applying the filmogenic formulation onto the produce. But the invention is not limited to the simultaneous application of the film-forming polysaccharide and the mineral; application of the two components in succession is also possible. Such an approach, that is based on a two-step process, consists of a first step, in which MgO is applied to the produce, e.g., with the aid of the suspension described in WO 2022/234582, and in the second step, the MgO-coated fruit is immersed in an aqueous polysaccharide solution, e.g., pectin solution, such that incorporation of MgO into the gel occurs in-situ, on the exterior surface of the produce. Thus, another aspect of the invention is a method which comprises applying filmogenic polysaccharide formulation (e.g., acidic polysaccharide, such as pectin) onto the exterior surface of a fruit or vegetable that was previously treated with an MgO suspension.

Another approach is to create a dual coating on the surface of the produce, consisting of two distinct Mg-containing layers. The first coating layer is obtained by treating (e.g., by dipping, spraying, or brushing) the produce with MgO aqueous suspension (1-10% by weight MgO, e.g. 3 to 7%; ~5% MgO powder suspended in water in the presence of a suspension aid (e.g., 0.1 to 0.2% by weight of phosphate-based dispersant) as described in WO 2022/234582). The first coating layer is allowed to dry, following which a second coating layer is applied on the produce, by treating the produce with a filmogenic formulation of a polysaccharide, to which MgO was added (such that the filmogenic formulation is nearly neutral or moderately alkaline), to create a glossy, smooth protective outer coating onto the produce, made of magnesium pectate, preferably with magnesium oxide particles embedded in the film.

Accordingly, another aspect of the invention is a method comprising applying a filmogenic formulation of a polysaccharide, to which MgO was added, such that the filmogenic formulation is nearly neutral or moderately alkaline, onto the exterior surface of a fruit or vegetable that was previously treated with an MgO suspension that was allowed to dry.

A produce (for example, a citrus fruit) provided with an edible coating resistant to fungal colonization, wherein the coating comprises a polysaccharide as described above and water-insoluble magnesium mineral such as magnesium oxide, is also part of the invention. For example, the coating is an edible film consisting of magnesium pectate and preferably magnesium oxide dispersed throughout the film; the coating is preferably wax free.

The magnesium pectate film produced by the formulation of the invention constitutes a good replacement to conventional fruit waxing. Experimental results reported below indicate that citrus fruits coated with magnesium pectate film, with magnesium oxide particles embedded in the film, either as a single coating or as the outer component of the bilayer dual coating described above (i.e., with a thin layer of magnesium oxide interposed between the surface of the produce and the magnesium pectate outer coating), show good resistance to natural decay and extended shelf life. Stable sugar and acid levels are kept in the fruit over a long storage period at room temperature. An acceptable fruit appearance is also maintained during storage. Specifically, produce coated with magnesium pectate film shows low levels of ethanol production (ethanol results from anaerobic fermentation of fruit sugars by yeast; hence low concentrations of ethanol in the fruit attest to minimal occurrence of undesired anaerobic, microbial-driven, decomposition processes).

For example, citrus fruit coated according to the invention shows ethanol content as low as 50 ppm, following storage at room temperature (15-25° C.) for seven days. A comparative fruit waxing was unable to suppress ethanol production to the same extent.

Accordingly, additional aspect of the invention includes storage-stable, essentially ethanol free fruit such as citrus fruit (<50 ppm EtOH, e.g., <35 ppm EtOH) provided with an edible coating comprising MgO and chelated Mg²⁺ (e.g., bound to polysaccharide such as pectin).

The composition of the coating can be determined, for example, by the following method. The coating can be separated from the fruit by heating, to melt the coating, followed by washing the fruit with hot water to collect an aqueous mixture with the immiscible melt. The liquified coating is washed with a water-soluble calcium salt, to exchange magnesium for calcium (calcium pectate is formed). The aqueous phase is recovered (e.g., by decantation) and Mg²⁺ is determined by conventional techniques. MgO presence in the non-aqueous phase is determined by calcination, followed by acidification to dissolve magnesium in solution, where magnesium is easily detectable by conventional techniques (ICP, inductively coupled plasma).

The amount of magnesium added to the fruit through the magnesium pectate film is usually from 50 to 150 ppm. When a thin layer of magnesium oxide is applied beneath the outer magnesium pectate film, then an additional amount of magnesium oxide is added to the fruit, e.g., from 100 to 300 ppm.

In the drawings

FIG. 1 shows photographs of MgO-modified gel (left) and nonmodified pectin gel (right).

FIG. 2 is a photograph of a reference gel, which in the absence of added MgO, showed development of fungal colonies and separation into solid and aqueous phases.

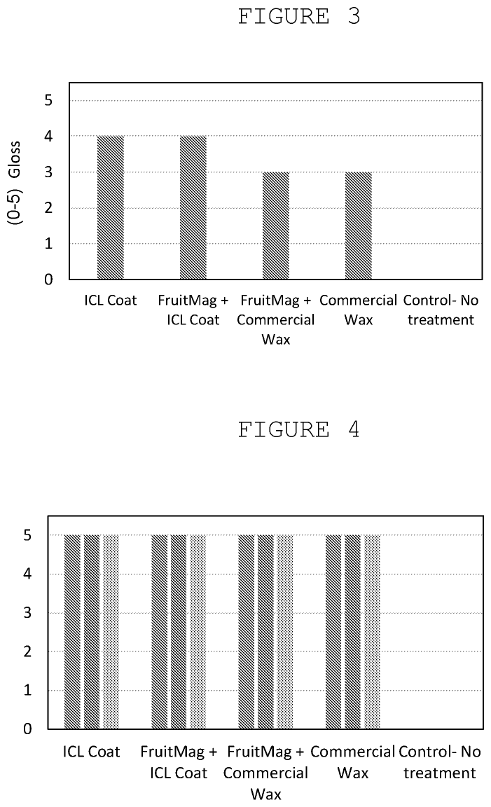

FIG. 3 is a bar diagram comparing the gloss of different coatings applied to oranges.

FIG. 4 is a bar diagram comparing the integrity of different coatings applied to oranges.

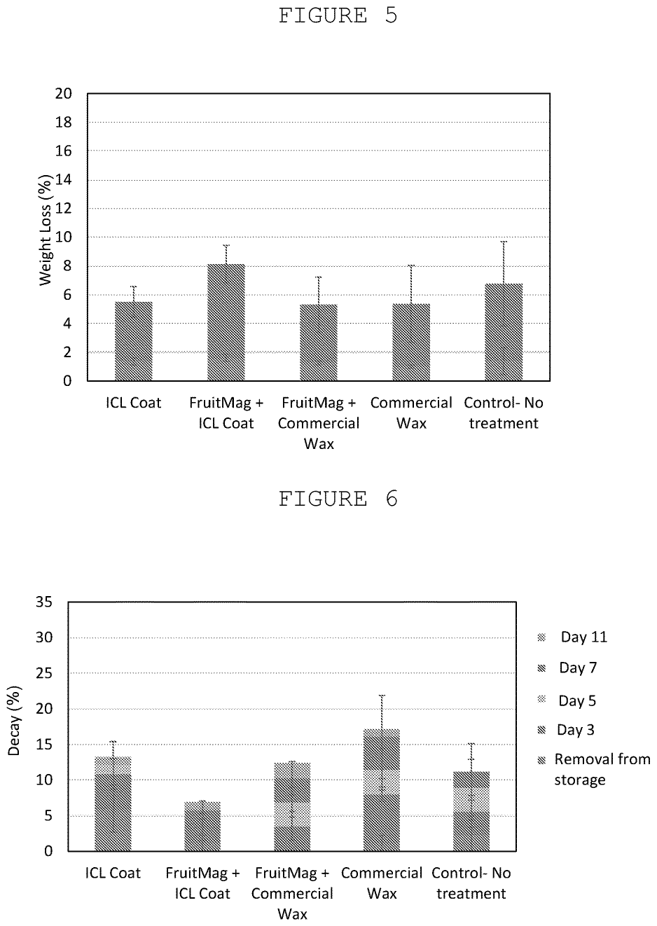

FIG. 5 is a bar diagram showing weight loss of differently coated oranges during storage at room temperature.

FIG. 6 is a bar diagram showing level of decay developed in differently coated oranges during storage at room temperature.

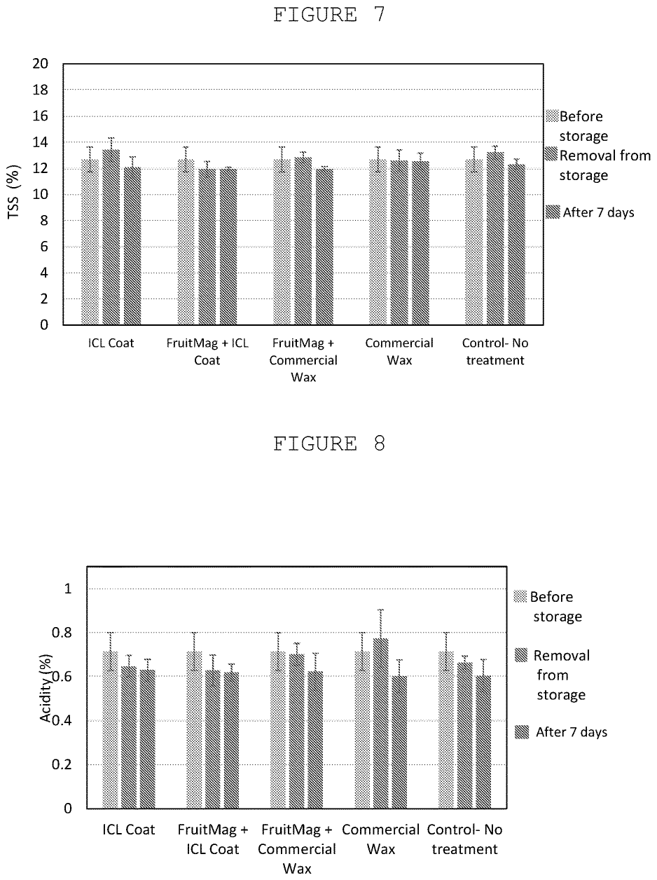

FIG. 7 is a bar diagram showing the sugar content of differently coated oranges during storage at room temperature.

FIG. 8 is a bar diagram showing acid levels in differently coated oranges during storage at room temperature.

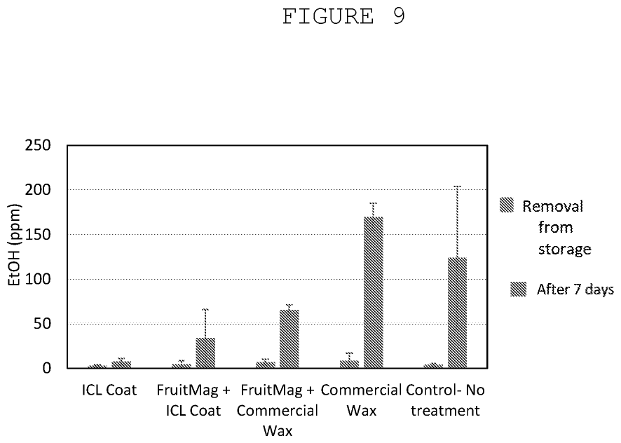

FIG. 9 is a bar diagram showing ethanol levels in differently coated oranges during storage at room temperature.

### EXAMPLES

### Example 1

### Effect of MgO Addition on Gel-Strength of Citrus Pectin Gels

A set of gels containing different amounts of MgO were prepared and left for solidification at 8° C. The gels were analyzed for firmness using a texture analyzer apparatus to discern the relative strength of the film that can be formed upon coating.

To prepare the gels, 2 g of low methoxy citrus pectin (from Sigma Aldrich) were dissolved in 50 cc of DI water while stirring at 600 rpm in a 250 ml plastic vessel. In a separate vessel, 5% MgO suspension was prepared by dispersing 5 g MgO in 95 ml of DI water using a disperser (IKA Ultra-Turrax). Then, while stirring, an appropriate volume of the MgO suspension was added dropwise to the pectin mixture. After the addition of MgO was completed, the formulations were stirred for an additional five minutes.

The homogenous formulations were capped and kept at room temperature (RT) for twenty-four hours and were then measured for gel strength. The gels were further kept at 8° C. for two weeks, and were analyzed again, to assess stability and firmness variation over time.

Gels were analyzed by the modified Bloom test (modified probe diameter) using a texture analyzer (Stable Micro Systems). Probe diameter was 20 mm, depth of: 4 mm, speed of penetration was 0.2 mm/s. The results are expressed as the gel strength in units of [g] of the tested gel (corollary to the Bloom number; the weight in grams needed by a specified plunger to depress the surface of the gel by a specified value).

The results of the measurements, which were taken 24 h after the formulation was formed at RT, are shown in Table 1 (in triplicate).

TABLE 1

| MgO | Gel strength | Gel strength | Gel strength |
|---|---|---|---|
| [gr/50 ml] | Sample 1 [g] | Sample 2 [g] | Sample 3 [g] |
| 0 | 6.00 | 8.92 | 7.87 |
| 0.05 | 6.17 | 5.72 | 6.79 |
| 0.10 | 3.66 | 4.04 | 3.65 |
| 0.15 | 4.20 | 4.03 | 4.06 |
| 0.20 | 49.76 | 42.07 | 43.69 |
| 0.25 | 1403.91 | 2683.75 | 1150.55 |
| 1.00 | 3533.81 | 3263.38 | 3717 |

All formulations with 0.05 g to 0.25 g added MgO were acceptable, i.e., no phase separation, no development of fungal colonies, and the formulations were pourable/spreadable. Gel was formed with 0.2 gr MgO; the results tabulated in Table 1 show that the gel strength of 4% pectin gel (2 gr pectin in 50 ml of DI water) increases with an increasing concentration of MgO. With 0.2 gr of MgO added to the gel (1:10 weight ratio of MgO to pectin), the effect was visible as the gel solidified at RT over time. Thus, for a fruit coating application, a 1:15 to 1:10 ratio of MgO to pectin was found to show the most suitable gel strength.

The results of the measurements, which were taken 14 days after gel formation (during which period the gels were kept in a refrigerator), are shown in Table 2 (in triplicate).

TABLE 2

| MgO | Gel strength | Gel strength | Gel strength |
|---|---|---|---|
| [gr/50 ml] | Sample 1 [g] | Sample 2 [g] | Sample 3 [g] |
| 0 | — | — | — |
| 0.05 | — | — | — |
| 0.10 | 4.12 | 2.99 | 3.97 |
| 0.15 | 154.18 | 136.24 | 70.63 |
| 0.20 | 358.27 | 483.87 | 483.41 |
| 1.00 | 4095.96 | 3603.25 | 4179.25 |

The results tabulated in Table 2 attest to the good storage stability conferred to pectin gels by the addition of MgO, at refrigeration. In the absence of MgO, or with addition of a small amount (0.05 gr, 1:40 weight ratio of MgO to pectin), the gels underwent separation into two distinct phases with the passage of the 14 days test period. MgO-modified gels with at least a 1:20 weight ratio of MgO to pectin, e.g., from 1:13 to 1:10, kept at refrigeration, remained stable (>1:20), solidified and showed increased gel strength (>1:13).

### Example 2

### Effect of MgO Addition on Gel Stability and Development of Fungal Colonies in Citrus Pectin Gels

A set of pectin gels containing different amounts of MgO were prepared (powder blend was formed from commercial citrus pectin powder and MgO powder; the powder blend was added gradually to water under mechanical stirring; stirring was continued to obtain homogeneous liquid mixture which jellified at different, concentration dependent, time periods). The mixtures were visually inspected immediately after they were formed and 14 days later (kept at room temperature). The compositions and the observations made are tabulated in Table 3.

In addition, a reference gel was prepared by crushing orange peel in a blender with addition of water, filtrating the suspension formed and allowing the filtrate to solidify (it took about twenty-four hours for the filtrate to turn into a stable gel). A week elapsed, and development of fungal colonies took place concurrently with separation of the gel into solid and aqueous phases, as indicated by the photograph appended in FIG. 2.

TABLE 3

| | Water | pectin | MgO | | observations | observations |
|---|---|---|---|---|---|---|
| Ex. | (g) | (g) | (g) | pH | t = 0 (liquid) | t = 14 days (gel) |
| 2A | 50 | 1 | 0.05 | 9.7 | Homogeneous, slightly | Precipitation |
| | | | | | viscous. Filmogenic; | occurred (not of |
| | | | | | application on peach | MgO). No |
| | | | | | caused no change in | development of |
| | | | | | fruit appearance. | Fungal colonies was |
| | | | | | | observed. |
| 2B | 50 | 1 | — | 3.7 | Homogeneous, slightly | Precipitation |
| | | | | | viscous. Filmogenic; | occurred. |
| | | | | | application on peach | Development of |
| | | | | | caused no change in | Fungal colonies was |
| | | | | | fruit appearance. | observed |
| | | | | | | (FIG. 1, right) |
| 2C | 50 | 1 | 0.1 | 9.7 | Homogeneous, slightly | No development of |
| | | | | | viscous. Filmogenic; | fungal colonies was |
| | | | | | application on peach | observed. |
| | | | | | caused no change in | (FIG. 1, left) |
| | | | | | fruit appearance. | |
| 2D | 50 | 0.5 | 0.1 | — | Homogeneous, viscous. | Homogeneous gel. |
| | | | | | Fluidity was restored | Neither |
| | | | | | after stirring to | precipitation, nor |
| | | | | | obtain a filmogenic | development of |
| | | | | | formulation. | Fungal colonies was |
| | | | | | | observed. |
| 2E | 100 | 5 | 1 | — | Highly viscous; | Rigid gel, no |
| | | | | | settling of residual | development of |
| | | | | | MgO was observed. | fungal colonies. |

The results show that MgO-modified pectin formulations are gellable and filmogenic; they can create coating on fruits, and the presence of MgO confers good protection against fungi.

### Example 3

### Preparation of Filmogenic Formulation Using Pectin and its Application onto Citrus Fruit

Citrus peel (albedo and flavedo; 100 gr) was put into a laboratory blender. Water (200 ml) was added, and the content was blended at high speed until homogenization (yellowish homogenous suspension). The suspension was filtered through a cloth. The filtrate was left to settle. MgO (0.4 gr) was added to the filtrate while vigorously stirring at RT. The formulation formed was kept in a closed cup and can be used over long periods of time.

The formulation was applied on fresh citrus by 1) brushing, 2) dipping, and 3) spraying followed by brushing. The fruit was left to dry at 40-45 C.° for a short time, following which the fruit was transferred to drying at room temperature, thereby completing the formation of an edible film onto the fruit.

Sensory test indicated that coating appearance, smell and texture were all acceptable. Storage stability was evaluated at room temperature and refrigeration seven days after film formation, showing no changes in the quality of the coating.

### Example 4

### Storage Stability of Differently Coated Oranges: Comparing Between Magnesium Pectate Film of the Invention and Wax Coating

The filmogenic formulation of Example 3 was applied on oranges and the properties of the film produced and its effect on the fruit was examined and compared to fruit waxing.

Navel oranges were used in the study. Each treatment group included three sets, each set consisting of 30 oranges. The fruit was washed and dried before the treatment (i.e., the application of the coatings). A total of five different treatments were tested (including an untreated control group), as tabulated in Table 4.

TABLE 4

| Group | Treatment |
|---|---|
| 1 | dipping the fruit in the MgO pectate formulation |
| (ICL coat) | of Example 3, immediately removing the fruit, |
| | and drying. |
| 2 | dipping the fruit in 5% wt. suspension of MgO in |
| (FruitMag ® + | water formulated with a dispersant as described |
| ICL Coat) | in WO 2022/234582 for thirty seconds, drying |
| | the treated fruit, washing with water, drying |
| | again, dipping the fruit in the MgO pectate |
| | formulation of Example 3, immediately |
| | removing the fruit, and drying. |
| 3 | dipping the fruit in 5% wt. suspension of MgO |
| (FruitMag ® + | in water formulated with a dispersant as |
| commercial | described in WO 2022/234582 for thirty |
| wax) | seconds, drying the treated fruit, washing |
| | with water, drying again, dipping the fruit |
| | in oxidized polyethylene wax (Zivdar ® of Decco), |
| | immediately removing the fruit and drying. |
| 4 | dipping the fruit in oxidized polyethylene wax |
| (commercial | (Zivdar ® of Decco), immediately removing |
| wax) | the fruit and drying. |
| 5 | Untreated control |

The coated dried fruits were transferred to storage at 8° C. Samples were examined/analyzed for different properties at different times as set out below.

Surface gloss: Fruits were removed from storage after 1 day and inspected visually after twenty-four hours upon drying, to assess the glossiness of the peel of the fruit. The fruits were rated on a scale from 0 (worst) to 5 (best). The results are shown in the form of a diagram in FIG. 3, indicating that the MgO pectate coating conferred glossy, smooth surface to the fruits.

Coating coverage: Fruits were removed from storage after 1 day and subjected to sensory test after twenty-four hours and after three and seven days, to assess the integrity of the coating, i.e., lack of flacking. All coatings were equally good, as they remained intact over cold storage and subsequent storage at room temperature (RT), showing no defects in fruit coverage. The results are shown in a bar diagram in FIG. 4 using a 0 to 5 rating scale.

Weight loss: Ten fruits were randomly chosen from each set, weighed at t=0 (before the produce was placed in cold storage), after removal from the cold storage and after additional seven days during which the fruit was kept at RT storage. The decrease in weight over time, calculated relative to the weight measured at t=0, is shown by a stacked bar diagram in FIG. 5. The weight loss measured after cold storage was quite similar among the treatments, with low variability within the sample sub-set. Following seven days of storage at room temperature, treatments 1, 3 and 4 showed a decreased average weight loss when compared to treatment 2 and the control.

Fruit decay: All fruit were monitored for development of decay, identified by local softening of the fruit. The decay was measured at higher frequency, the first time twenty-four hours after the fruit was removed from the cold storage, and then after the lapse of 3, 5, 7 and 11 days at RT storage. The results are shown in FIG. 6 in the form of a stacked bar diagram. After 11 days at RT storage, the lowest decay rate was observed for treatment 2.

Sugar content: A total of 5 fruit from each treatment were analyzed for sugar content by taking a juice sample and measuring in a refractometer. The fruit were sampled at three different times: 1) upon its receipt from the packhouse (i.e., just before the fruit was placed in cold storage); 2) after the fruit was removed from the cold storage, and then once again, 3) after seven days at RT storage. The results are shown in FIG. 7 in the form of a bar diagram; each treatment is represented by three adjacent bars corresponding (from left to right) to the three measurements mentioned above. It is seen that the sugar content of the fruit was not affected by the treatment and was not varied with the passage of time.

Acid content: A total of 5 fruit from each treatment were analyzed to determine acid content using citrus acidity meter. The fruit were sampled at three different times: 1) upon its receipt from the packhouse (i.e., just before the fruit was placed in cold storage); 2) after the fruit was removed from the cold storage, and once again, 3) after seven days at RT storage. The results are shown in FIG. 8 in the form of a bar diagram. At the end of the experiment, i.e., after storage at room temperature, the treatments showed comparable results.

Ethanol content: A total of 5 fruit from each treatment were analyzed to determine ethanol content (samples were taken from the fruit and analyzed by gas chromatography). The fruit were sampled at two different times: 1) after the fruit was removed from the cold storage, and once again, 2) after seven days at RT storage. Ethanol content is indicative of occurrence of anaerobic processes, i.e., microbial decomposition. Hence, the lower the ethanol level measured in the fruit, the more effective the treatment. The results are shown in FIG. 9 in the form of a bar diagram; each treatment is represented by a pair of adjacent bars corresponding to the two measurements mentioned above. Treatment 4 and the control group 5 showed elevated levels of ethanol. Coating the fruit with magnesium pectate filmogenic formulation of the invention, either alone (treatment 1), or after the application of MgO aqueous suspension on the fruit (treatment 2), showed effective inhibition of ethanol formation (the lowest amount of ethanol was measured in fruits coated with the magnesium pectate film).

Overall, the coating of the invention, i.e., an edible film of magnesium pectate (with MgO dispersed throughout the film) was shown to provide effective protection to the fruit and increased shelf life, inhibiting decay during storage (especially when applied after the fruit was treated with an aqueous suspension of magnesium oxide, i.e., the bilayer, dual coating configuration). The coating of the invention is breathable. As to fruit appearance (gloss and integrity of the coating) and fruit properties (sugar and acidity levels), it was shown that the magnesium pectate film coating of the invention was comparable to conventional wax coating.

### Example 5

### Preparation of Filmogenic Formulation Using Pectin

Demineralized water (200 g) and glycerin (2 g) were added to a 400 ml flat-bottom glass vessel and mixed with high-shear mixer (Ultra-Turrax T50) over two minutes at 400 rpm. Next, pectin (4 g; P9135 from Sigma-Aldrich, which is pectin from citrus peel (Poly-D-galacturonic acid methyl ester, galacturonic acid 74.0%, dried basis), magnesium oxide (0.5 g; grade HA4 from Dead See Bromine Company) and sucrose (0.5 g; from Bayer Health Care) were added to the vessel and the stirring with the high-shear mixer continued over additional ten minutes at 800 rpm.

The resultant crosslinked pectin consisting of magnesium pectate was obtained as viscous liquid of grayish color. Within eight hours, it turned into a gel, which was used to coat oranges by dipping and brushing. Glossy, smooth, flaking-free coating was obtained.

1. A method of prolonging the shelf life of postharvest produce, comprising creating on the exterior surface of the produce an edible coating that contains one or more polysaccharides modified by a basic alkaline earth metal compound.

2. The method according to claim 1, wherein the polysaccharide is acidic.

3. The method according to claim 2, wherein the acidic polysaccharide is pectin.

4. The method according to claim 1, wherein the basic alkaline earth metal compound is magnesium compound selected from the group consisting of magnesium oxide, magnesium hydroxide, magnesium hydroxide carbonate, magnesium carbonate and mixtures thereof.

5. The method according to claim 4, wherein the magnesium compound is magnesium oxide.

6. The method according to claim 1, comprising applying filmogenic formulation of a polysaccharide, to which MgO was added, such that the filmogenic formulation is nearly neutral or moderately alkaline, onto the exterior surface of a fruit or vegetable, and drying to form an edible film coating.

7. The method according to claim 1, comprising applying a filmogenic formulation of a polysaccharide, to which MgO was added, such that the filmogenic formulation is nearly neutral or moderately alkaline, onto the exterior surface of a fruit or vegetable that was previously treated with an MgO suspension that was allowed to dry, and drying the filmogenic formulation to form an edible film coating.

8. The method according to claim 1, comprising applying a filmogenic formulation of a polysaccharide onto the exterior surface of a fruit or vegetable that was previously treated with an MgO suspension.

9. The method according to claim 3, wherein the pectin is supplied in a solubilized form in a liquid phase that was separated from a slurry of comminuted fruit and water.

10. The method according to claim 9, wherein the pectin is citrus pectin.

11. The method according to claim 9, wherein the slurry is produced by cutting and crushing fruit peels in water to reduce the peels to finely divided particles.

12. The method according to claim 1, wherein the postharvest produce is a citrous fruit.

13. A nearly neutral-moderately alkaline filmogenic formulation comprising a polysaccharide and a basic alkaline earth metal compound in water.

14. The filmogenic formulation according to claim 13, wherein the basic alkaline earth metal compound is magnesium compound selected from the group consisting of magnesium oxide, magnesium hydroxide, magnesium hydroxide carbonate, magnesium carbonate and mixtures thereof.

15. The filmogenic formulation according to claim 14, wherein the magnesium compound is magnesium oxide.

16. The filmogenic formulation according to claim 15, wherein the polysaccharide is an acidic polysaccharide.

17. The filmogenic formulation according to claim 16, wherein the acidic polysaccharide comprises pectin.

18. The filmogenic formulation according to claim 17, wherein the pectin is solubilized fruit pectin recovered from a slurry of comminuted fruit.

19. The filmogenic formulation according to claim 15, further comprising a plasticizer and mono- or di-saccharide.

20. The moderately alkaline filmogenic formulation according to claim 15, with 7.5≤pH≤10.5.

21. (canceled)

22. (canceled)

23. A produce provided with an outer coating consisting of edible film made of magnesium pectate, with magnesium oxide particles dispersed throughout the film.

24. The produce according to claim 23, further comprising a thin layer of magnesium oxide interposed between the surface of the produce and the magnesium pectate outer coating.

25. The produce according to claim 23, wherein the produce is storage stable, essentially ethanol free, citrus fruit, with ethanol content of less than 50 ppm when measured after seven days of room temperature storage.

26. (canceled)
